(19) United States
(12) Patent Application Publication
(10) Pub. No.: US 2006/0075615 A1
(43) Pub. Date: Apr. 13, 2006

(54) Cushion with aesthetic exterior

(75) Inventor: Surendra Khambete, West Bloomfield, MI (US)

Correspondence Address: CARLSON, GASKEY & OLDS, P.C., 400 WEST MAPLE ROAD, SUITE 350, BIRMINGHAM, MI, 48009, US

(73) Assignee: IndraTech LLC

(21) Appl. No.: 11/259,769

(22) Filed: Oct. 27, 2005

Related U.S. Application Data
(63) Continuation-in-part of application No. 11/246,609, filed on Oct. 7, 2005.
(60) Provisional application No. 60/522,501, filed on Oct. 7, 2004.
(60) Provisional application No. 60/522,503, filed on Oct. 7, 2004.
(60) Provisional application No. 60/522,504, filed on Oct. 7, 2004.

(51) Int. Cl. B68G 7/00

(52) U.S. Cl. 29/91.1; 297/218.2; 29/527.1

(57) ABSTRACT

An aesthetic cushion assembly includes an aesthetic layer and a fiber cushion bonded to the aesthetic layer. In one example, the aesthetic layer extends beyond a periphery of the fiber cushion to provide flaps that can be used to secure the aesthetic cushion assembly to a commercial product, such as a chair. The flaps can also be used to form a finished product such as a mattress. The aesthetic cushion assembly can be manufactured using a variety of methods. In one example, the fiber is blown onto the aesthetic layer and the fiber and aesthetic layer are heated together. In another example, the fiber is blown into a cavity and separately heated or a simple batt is generated by non-woven manufacturing methods. The fibers are molded into a desired article shape to form a fiber cushion. The fiber cushion and/or aesthetic layer are then trimmed, if necessary, to provide a finished article shape. The aesthetic cushion can then be shipped to a customer and only requires installation onto a commercial product. A machine used to form a mattress according to the inventive method is also disclosed.

This application is a continuation-in-part application of U.S. application Ser. No. 11/246,609, filed on Oct. 7, 2005, which claims priority to provisional applications Nos. 60/522,501; 60/522,503; and 60/522,504 all of which were filed Oct. 7, 2004.

### BACKGROUND OF THE INVENTION

The present invention relates to an aesthetic cushion assembly and a method of manufacturing the same.

Cushions are used in numerous manufactured articles in many industries, such as aircraft, marine, furniture, automotive and medical. For example, polyurethane cushions are used on seat bottoms in the furniture industry. Typically, at a furniture manufacturing facility, the cushion is secured to a frame of the seat bottom and an aesthetic layer is separately secured over the cushion. Alternatively, the cushion is stuffed into a cut and sewn fabric casing and together secured to the frame as a cushion or back support. Other layers may be used with the cushion and aesthetic layer to provide additional functionality. For example, foam cushions are sometimes covered in polyester fabric to reduce flammability of the cushion.

All of the assembly and trimming of the cushion and layers occurs at the furniture manufacturing facility that produces the final commercial product. Each component may be provided by a different vendor, which can complicate manufacturing and increase the manufacturing cost. As is common in many industries, manufacturers of final commercial products desire to reduce assembly and labor costs associated with manufactured articles. Therefore, what is needed is an aesthetic cushion assembly that can be provided to a manufacturer of a final commercial product that does not need to be cut or sewn. Polyurethane cushions, however, cannot be used to cost effectively provide an aesthetic cushion assembly. For example, in order to achieve a three-dimensional shape the polyurethane must be formed independently using a separate cushion manufacturing process.

### SUMMARY OF THE INVENTION

The inventive method provides an inventive aesthetic cushion assembly that includes an aesthetic layer and a fiber cushion bonded to the aesthetic layer. In one example, the aesthetic layer extends beyond a periphery of the fiber cushion to provide flaps that can be used to secure the aesthetic cushion assembly to a commercial product, such as a chair.

The aesthetic cushion assembly can be manufactured using a variety of methods. In one example, the fiber is blown onto the aesthetic layer and the fiber and aesthetic layer are heated together. In another example, the fiber is blown into a cavity and separately heated. The fibers are molded into a desired article shape to form a fiber cushion. The fiber cushion and/or aesthetic layer are then trimmed, if necessary, to provide a finished article shape. The aesthetic cushion can then be shipped to a customer and only requires installation onto a commercial product. Accordingly, the assembly time and cost of the customer producing the commercial product is reduced.

A mattress can be manufactured according to the inventive aesthetic cushion assembly method. First and second aesthetic layers are secured to a fiber batt. In one example a press is used to aid in bonding the first and second layers to the fiber batt and to form indentations in the assembly for aesthetic purposes. The flaps are used to cover the sides of the fiber batt and are secured at the edges by stitching and/or using piping to provide a finished appearance.

The machine includes a heater that heats the fiber batt. The heated fiber batt is fed to a laminator, which applies the fabric to the heated fiber batt. Hot wire trimmers are used to trim the fabric to a desired dimension. The unfinished mattress assembly enters a station where the assembly is engaged by forms under pressure for a time to enhance bonding and provide an aesthetic pattern on the assembly.

These and other features of the present invention can be best understood from the following specification and drawings, the following of which is a brief description.

### BRIEF DESCRIPTION OF THE DRAWINGS

FIG. 1 is a cross-sectional view of an inventive aesthetic cushion assembly.

FIG. 2 is one inventive method of providing the aesthetic cushion assembly.

FIG. 3 is the aesthetic cushion assembly used for a furniture seat bottom.

FIG. 4 is another inventive method of providing the aesthetic cushion assembly.

FIG. 5A is a schematic view of a machine suitable for manufacturing the inventive aesthetic cushion assembly.

FIG. 5B is a top elevational view of a portion of a press shown in FIG. 5A.

FIG. 6 is a top elevational view of an unfinished inventive fiber batt/aesthetic layer combination.

FIG. 7 is a cross-sectional view of a finished fiber batt/aesthetic layer combination.

### DETAILED DESCRIPTION OF THE PREFERRED EMBODIMENT

FIG. 1 depicts the inventive aesthetic cushion assembly 10. The assembly 10 includes a polyester cushion 12 along with multiple layers 14 and 15 that are together secured or bonded to an aesthetic layer 16. Although the cushion 12 is described as being constructed from a polyester material, other materials may be used. However, a polyester material and polyester blends are preferred since bonding of the other layers to the polyester cushion to provide a finished assembly 10 can be done efficiently. The cushion 12 and layers 14 and 15 (and other layers, if used) are polyester-based in one example, which provides a completely recyclable end product, unlike polyurethane. The polyester is selected to have desirable acoustic and flammability properties for the application in which the end product is used. The polyester fiber may include a staple or matrix fiber along with some low and high melt binder fibers, which also may have elastomeric properties.

In one example, the layer 14 may be an adhesive used to secure the aesthetic layer 16 to the other layer 15. Some examples of suitable adhesives are polyester-, acrylic-, or polypropylene-based adhesives. It is typically desirable to use adhesives that can stretch along with the aesthetic layer while retaining its bond to both the cushion 12 and aesthetic layer 16.

The other layer may be a functional layer, for example, an acoustic layer, a “soft touch” layer or a fire retardant layer. The aesthetic layer 16 may, for example, be a leather, vinyl or fabric material specified by the customer having an aesthetically pleasing outer surface 18. Of course, any number and types of layers may be used.

The polyester cushion 12 includes a periphery 13. The aesthetic layer 16 extends beyond the periphery 13 to provide flaps 17 for securing the assembly 10 to the manufactured article. The assembly 10 is produced at a manufacturing facility with a desired shape. That is, the cushion 12 and layers 14, 15 and 16 have a shape that is usable by the manufacturer of the finished product with little or no additional work required. The finished assembly 10 can then be shipped to a customer facility that is manufacturer of a final commercial product as a unit. The finished assembly is installed onto a commercial product without the typical assembly of multiple components and trimming that takes place at such a facility.

One example method 20 of manufacturing the assembly 10 is shown schematically in FIG. 2. The method 20 includes the step of blowing the polyester fibers into a cavity to create a fiber batt, for example, and the fibers are then heated to a desired temperature, as indicated at block 22. Heating the fibers is desirable so that they bond to one another during the molding process. At the same time, the aesthetic layer 16 and other layers 14 and 15 are heated, as indicated at block 24. The heated fibers and layers 14, 15 and 16 are combined in a mold, as indicated at block 25. Heating the layers 14, 15 and 16 better enables them to be bonded to one another and to the fibers. The fibers are molded along with the layers 14, 15 and 16, as indicated at block 26, to provide a desired shape polyester cushion 12. The desired shape may or may not be an unfinished article shape in need of trimming.

The aesthetic layer 16 extends beyond the periphery 13 of the polyester cushion 12 at this stage. In the example shown, the cushion 12 has exposed sides that extend transversely from an inner surface of the aesthetic layer 16. The layers 14, 15 and 16 and polyester cushion 12 are trimmed, as necessary, as indicated at block 28, to provide a finished assembly 10 having a finished article shape that is useable by a manufacturer of final products, preferably without the need for further trimming or assembly. The assembly 10 can then be shipped to the customer, as indicated at block 29. The aesthetic layer 16 may also be trimmed, if desired.

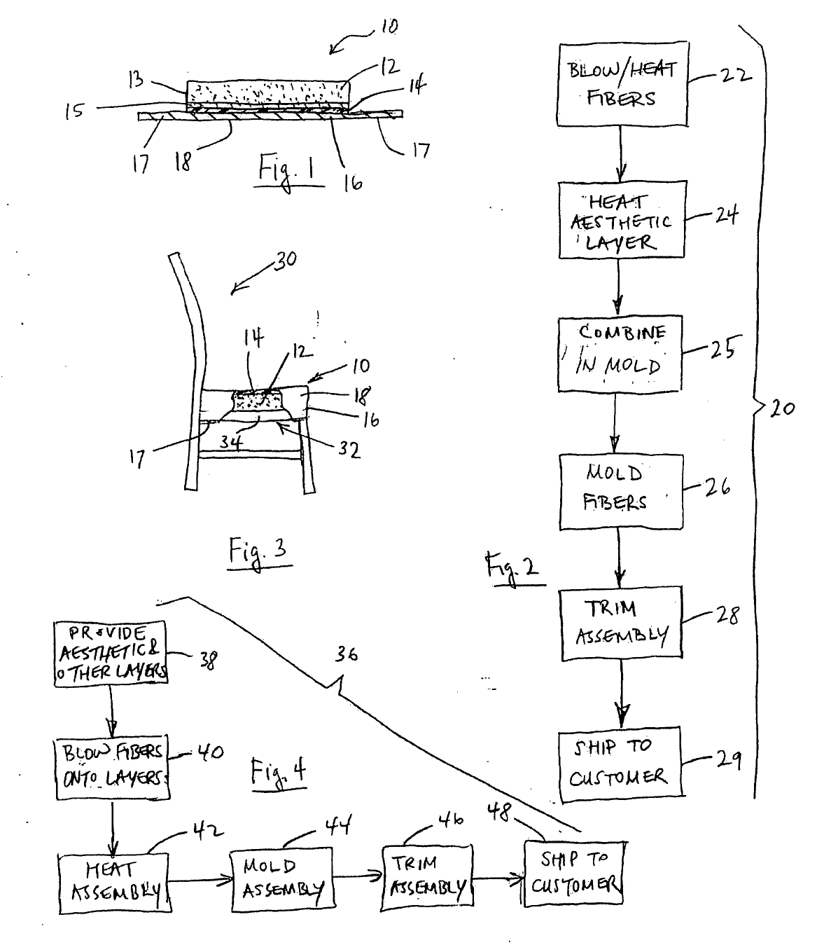

The assembly 10 is installed onto a commercial product 30, as shown in FIG. 3. In the example shown, the commercial product 30 is a typical chair manufactured in the furniture industry. Of course, the inventive assembly 10 and methods may be used in any industry. The chair has a seat bottom 32 with a frame 34. The flaps 17 are wrapped around a portion of the frame 34 and secured thereto. Preferably, no trimming or assembly is required by the chair manufacturer. That is, the assembly 10 is manufactured to the desired dimensions of the seat manufacturer to increase the efficiency and reduce the cost of the chair manufacturer.

Another example inventive method 36 is shown schematically in FIG. 4. The method 36 includes providing the layers 14, 15 and 16, as indicated at block 38, in a desired orientation. Polyester fibers are blown onto the layers 14, 15 and 16, as indicated at block 40. The layers 14, 15 and 16 and fibers are heated together to a desired temperature, as indicated at block 42. The fibers are molded into a desired shape to provide a desired shape polyester cushion 12, as indicated at block 44. The aesthetic layer 16 can also be molded along with the layers 14, 15 and 16. The cushion 12 and layers 14, 15 and 16 are trimmed as necessary, as indicated at block 46. The finished assembly 10, which preferably requires no additional assembly or trimming, is shipped to the customer, as indicated at block 48.

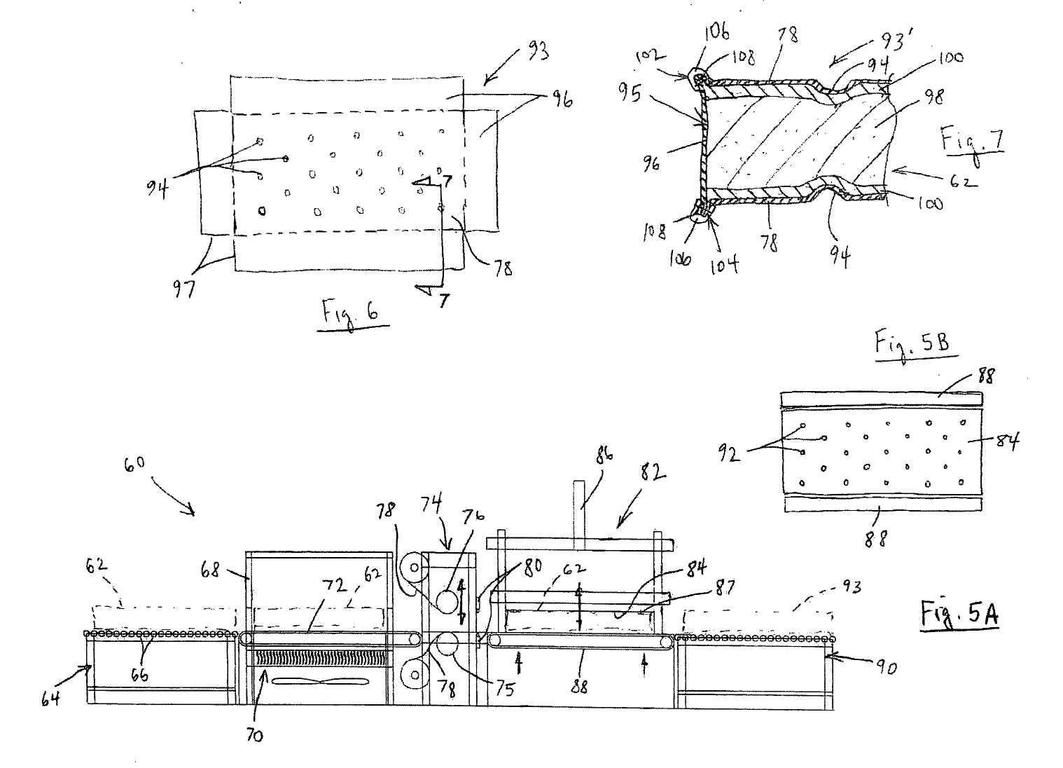

The above invention is useful for the manufacture of mattresses, for example. One example machine 60 for manufacturing mattresses is shown in FIGS. 5A and 5B. Of course, the inventive machine 60 can be used to manufacture any number of articles. An example mattress produced with the inventive machine and method is shown in FIGS. 6 and 7.

Referring to FIGS. 5A and 5B, the machine 60 includes a conveyor 64 with rollers 66 that feed a fiber batt 62 to a station with a heater 70. The fiber batt can be pre-trimmed, for example, to any desired shape. The heater 70 includes an enclosure 68 that surrounds the fiber batt 62 for efficient heating.

The heated fiber batt is fed by a belt conveyor 72 through a laminator 74. Laminator 74 includes a fixed roller 75 that applies fabric 78 to a bottom surface of the fiber batt 62. An adjustable roller 76 applies the fabric 78 to a top surface of the fiber batt 62. The fabric 78 provides an aesthetic layer or covering to a mattress in the example shown. In one example, the fabric 78 can be a polyester fabric or any other suitable fabric. The fabric 78 may include an adhesive layer that readily adheres to the fabric 78 to the heated fiber batt 62.

Hot wire cutters 80, or any other suitable trimming device, is used to cut the fabric 78 to a desired dimension. In the example embodiment, at least one of the aesthetic layers of fabric 78 is trimmed to provide flaps that can be used to cover the sides of the fiber batt 62 to provide a pleasing appearance.

The fiber batt 62 with the fabric 78 is fed to a press 82. Grippers 87 are used to hold the fabric 78 in a desired position. The press 82 includes an actuator 86 that moves a form 84 having a pattern into engagement with the fiber batt and fabric assembly. Referring to FIG. 5B, the press 82 may include thin, spaced apart belts 88 with a fixed form 84 arranged between the belts 88. In one example, the spaced apart forms 84 have the same pattern so that the opposing sides of the assembly will have the same appearance when the press 82 applies pressure to the fiber batt and fabric assembly.

Once the fiber batt and fabric assembly have been engaged using a desired pressure for a desired length of time, the belts 88 feed the fiber batt and fabric assembly to a conveyor 90 for additional processing or shipping. An example of an unfinished mattress 93 manufactured using the machine 60 is shown in FIG. 6. The fabric 78 and fiber batt 62 include indentations 94 formed by protrusions 92 provided on the forms 84 (shown in FIG. 5B). The protrusions 92 “pull” the fabric 78 at the indention 94 to create a wrinkled look.

The unfinished mattress 93 can be further processed at the same facility or a customer facility to provide a finished mattress 93′, shown in FIG. 7. The fiber batt 62 can be constructed from multiple layers. For example, the fiber batt 62 includes a support layer 98 for providing firmness and soft touch layers 100 on either side of the support layer 98 to provide a plush feel to the user.

At least one of the fabric layers 78 includes flaps 96 for covering the sides 95 of the fiber batt 62. Edges 97 of the flaps 96 (shown in FIG. 6) can be secured to one another, such as by sewing, to provide a finished appearance at the corners of the mattress 93′. A fold 102 and seam 104 are arranged on opposite sides of the finished mattress 93′. The fold 102 and seam 104 are covered in piping 106 using stitching 108 to provide an appearance that is common with mattresses.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of forming an aesthetic cushion assembly comprising the steps of:
a) providing a fiber batt and first and second aesthetic layers;
b) bonding the first and second aesthetic layer to the fiber batt; and
c) forming at least one of first and second aesthetic layers and the fiber batt to a finished article shape.

2. The method according to claim 1, wherein step a) includes unrolling the first and second aesthetic layers onto the fiber batt.

3. The method according to claim 1, comprising the step of heating the fiber batt separately from the aesthetic layers prior to performing step b).

4. The method according to claim 1, wherein step b) includes applying pressure to the fiber batt and first and second aesthetic layers.

5. The method according to claim 1, wherein step c) includes trimming at least one of the first and second aesthetic layers to provide an exposed periphery on the fiber batt, the periphery extending transversely from an inner surface of the one of the first and second aesthetic layers, the one of the first and second aesthetic layers providing a flap extending away from the periphery.

6. The method according to claim 5, wherein the trimming step includes heating a wire and cutting the one of the first and second aesthetic layers with the heated wire.

7. The method according to claim 5, comprising the step of covering the periphery with the flap to enclose a side of the fiber batt.

8. The method according to claim 1, wherein the fiber batt comprises polyester fibers.

9. The method according to claim 1, wherein step c) includes engaging one of the first and second aesthetic layers with a form having a pattern to provide a complementary pattern to the pattern in the fiber batt.

10. An aesthetic cushion assembly comprising:
an aesthetic layer having an inner surface; and
a fiber batt having a first side bonded to the inner surface, the fiber batt having a periphery defining a boundary of the first side, the aesthetic layer extending beyond the periphery to provide an assembly flap, the assembly flap covering a second side extending from the periphery transverse to the first side.

11. The aesthetic cushion assembly according to claim 10, wherein an adhesive layer is arranged between the fiber batt and the aesthetic layer.

12. The aesthetic cushion assembly according to claim 11, wherein the fiber batt includes an inner layer and an outer layer, the adhesive layer arranged between the outer layer and the aesthetic layer.

13. The aesthetic cushion assembly according to claim 10, wherein the fiber batt comprises polyester fiber.

14. The aesthetic cushion assembly according to claim 13, wherein the aesthetic layer is a polyester layer.

15. The aesthetic cushion assembly according to claim 10, wherein the aesthetic layer and fiber batt include indentations on the first side.

16. The aesthetic cushion assembly according to claim 10, wherein a piping is secured near the periphery to provide a finished edge.

17. A machine for manufacturing a fiber cushion assembly comprising:
a heater for heating a fiber batt;
a laminator for applying fabric to the fiber batt; and
a press for applying pressure to the fabric and fiber batt.

18. The machine according to claim 17, wherein a trimmer is arranged between the laminator and the press for cutting the fabric to a desired dimension.

19. The machine according to claim 17, wherein the press include a form having a pattern for providing indentations on the fabric and fiber batt.
